(19) United States
(12) Patent Application Publication
(10) Pub. No.: US 2020/0160244 A1
(43) Pub. Date: May 21, 2020

(54) System and Method for Unsolicited Offer Management

(71) Applicant: Simple Lobby LLC, Southlake, TX (US)

(72) Inventors: Donald Paul Brandt, Ringgold, GA (US); Tom Van Oevelen, Southlake, TX (US); Vahid Raymond Yamartino, Roanoke, TX (US)

(73) Assignee: Simple Lobby LLC, Southlake, TX (US)

(21) Appl. No.: 16/678,399

(22) Filed: Nov. 8, 2019

Related U.S. Application Data
(60) Provisional application No. 62/767,691, filed on Nov. 15, 2018.

(51) Int. Cl. G06Q 10/06; G06F 17/24; G06Q 10/08; H04L 29/06

(52) U.S. Cl. CPC G06Q 10/06312; G06F 17/243; H04L 63/0263; G06Q 10/087; H04L 63/101; G06Q 10/0635

(57) ABSTRACT

Disclosed is a system and method for unsolicited offer management. A communication gateway receives a first structured offer object and selectively communicates the object to a recipient account. In this manner, the operator of the recipient account may selectively control the communication of unsolicited offers.

### CROSS-REFERENCE TO RELATED APPLICATION(S)

This application claims priority to, and the benefit of, U.S. Pat. App. No. 62/767,691 entitled “UNSOLICITED OFFER MANAGEMENT SYSTEM,” filed on Nov. 15, 2018, the contents of which are hereby incorporated herein by reference in its entirety for any purpose.

### FIELD

The present disclosure relates generally to a system and method for managing unsolicited offers, and more specifically, a system and method for managing unsolicited offers transmitted via an electronic telecommunication medium.

### BACKGROUND

The statements in this section merely provide background information related to the present disclosure and may not constitute prior art. Frequently, businesses receive many unsolicited offers for goods and services from vendors and potential vendors. Such offers frequently comprise unstructured data delivered in many contexts. Moreover, such offers are often inconsistent and evade statistical and/or heuristic analysis. Furthermore, such offers often contribute to congestion of an electronic communication medium, being unsolicited and received in high volumes. Thus there is a need for a system and method as discussed herein.

### SUMMARY

An electronic method of unsolicited offer management is provided. The method may include multiple aspects. Non-transient computer readable media may also be provided. Additionally, systems may be provided.

A method of unsolicited offer management is provided. The method may include receiving, by a communication gateway of an unsolicited offer controller, a first structured offer object from a first account. The method may also include parsing, by the communication gateway, the first structured offer object to determine at least one first recipient account for the first structured offer object. Yet furthermore, the method may contemplate validating, by the communication gateway, access rights of the first account to transmit the first structured offer object to the at least one first recipient account. Finally, the method may recite in response to the access rights being not valid, setting a pause flag within the first structured offer object.

The method of unsolicited offer management may include additional features. For example, the method may include preparing, by a data structuring engine of the unsolicited offer controller and prior to the receiving the first structured offer object, first screen display objects including a fillable form structured and arranged to capture structured data. The method may include transmitting, by the communication gateway of the unsolicited offer controller, the first screen display objects to a dashboard of the first account. The first structured offer object may include structured data captured by the fillable form.

The method of unsolicited offer management may include one or more yet further features. For instance, the method may include discarding the first structured offer object in response to the pause flag being set. The method may include transmitting the first structured offer object to the at least one first recipient account. Such methods may include quarantining, by the at least one first recipient account, the first structured offer object in a screen display area for structured offer objects having the pause flag set in response to receiving, by the at least one first recipient account, the first structured offer object with the pause flag set.

In various instances, the method includes retrieving a previous offers object from a data store. Further included may be an aspect of extracting, by a trend extractor of the unsolicited offer controller, at least one price trend from the previous offers object, and transmitting by the communication gateway of the unsolicited offer controller, data representing the at least one price trend to the at least one first recipient account. In yet further instances, the method contemplates displaying, by the at least one first recipient account, data representing a comparison of the at least one price trend to the first structured offer object on a user readable screen display.

Also provided is a non-transient computer readable medium containing program instructions for causing a computer to perform a method of unsolicited offer management. The method includes receiving, by a communication gateway of an unsolicited offer controller, a first structured offer object from a first account. The method includes parsing, by the communication gateway, the first structured offer object to determine at least one first recipient account for the first structured offer object. The method also includes validating, by the communication gateway, access rights of the first account to transmit the first structured offer object to the at least one first recipient account. The method also includes, in response to the access rights being not valid, setting a pause flag within the first structured offer object.

In various instances, the non-transient computer readable medium contains additional program instructions. The program instructions cause a computer to perform a method of unsolicited offer management further including preparing, by a data structuring engine of the unsolicited offer controller and prior to the receiving the first structured offer object, first screen display objects including a fillable form structured and arranged to capture structured data, and transmitting, by the communication gateway of the unsolicited offer controller, the first screen display objects to a dashboard of the first account. In various instances, the first structured offer object includes structured data captured by the fillable form.

In various instances, the non-transient computer readable medium contains additional program instructions. The program instructions cause a computer to perform a method of unsolicited offer management further including discarding the first structured offer object in response to the pause flag being set. The method may further include transmitting the first structured offer object to the at least one first recipient account. The method may further include quarantining, by the at least one first recipient account, the first structured offer object in a screen display area for structured offer objects having the pause flag set in response to receiving, by the at least one first recipient account, the first structured offer object with the pause flag set.

In further instances, the non-transient computer readable medium contains additional program instructions. The program instructions cause a computer to perform a method of unsolicited offer management further including retrieving a previous offers object from a data store, and extracting, by a trend extractor of the unsolicited offer controller, at least one price trend from the previous offers object, and transmitting by the communication gateway, data representing the at least one price trend to the at least one first recipient account. Further aspects may include displaying, by the at least one first recipient account, data representing a comparison of the at least one price trend to the first structured offer object on a user readable screen display.

A communication gateway of an unsolicited offer management controller is discussed. The communication gateway may be configured to receive a first structured offer object from a first account, parse the first structured offer object to determine at least one first recipient account for the first structured offer object, and validate access rights of the first account to transmit the first structured offer object to the at least one first recipient account. The communication gateway may set, in response to the access rights being not valid, a pause flag within the first structured offer object.

The unsolicited offer management controller that has the communication gateway may have other components too. For example, the unsolicited offer management controller may include a data structuring engine connected to the communication gateway and configured to prepare, prior to the receiving the first structured offer object, first screen display objects including a fillable form structured and arranged to capture structured data. The communication gateway may be configured to transmit the first screen display objects to a dashboard of the first account, and the first structured offer object may include structured data captured by the fillable form.

The communication gateway may discard the first structured offer object in response to the pause flag being set. The communication gateway may transmit the first structured offer object to the at least one first recipient account.

The unsolicited offer management controller may include a data store transceiver configured to retrieve a previous offers object from a data store. The controller may also have a trend extractor configured to extract at least one price trend from the previous offers object. The communication gateway may transmit data representing the at least one price trend to the at least one first recipient account. In various embodiments, the at least one first recipient account displays data representing a comparison of the at least one price trend to the first structured offer object on a user readable screen display.

### BRIEF DESCRIPTION OF THE DRAWINGS

For a more complete understanding of various embodiments of the present disclosure and the advantages thereof, reference is now made to the following brief description, taken in connection with the accompanying drawings and detailed description, wherein like reference numerals represent like parts, and in which:

FIG. 1 illustrates a unsolicited offer system, in accordance with various embodiments;

FIG. 2 illustrates a unsolicited offer controller of the unsolicited offer system, in accordance with various embodiments;

FIG. 3 illustrates a unsolicited offer data store of the unsolicited offer system, in accordance with various embodiments; and

FIG. 4 illustrates a method of unsolicited offer management by a unsolicited offer system, in accordance with various embodiments.

### DETAILED DESCRIPTION

The present disclosure is generally described in detail with reference to embodiments illustrated in the drawings. However, other embodiments may be used and/or other changes may be made without departing from the spirit or scope of the present disclosure. The illustrative embodiments described in the detailed description are not meant to be limiting of the subject matter presented herein.

Reference will now be made to the exemplary embodiments illustrated in the drawings, and specific language will be used to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

Unsolicited emails, cold calls, and other sales efforts rob organizations and individuals of time and also harm salespeople by obscuring potentially relevant communications with large amounts of non-relevant communications. The amount of unsolicited emails, cold calls, and walk-in sales (especially with the advent of CRMs) has grown at a feverish pace, robbing organizations and individuals of precious time and resources, and robbing sales people of a proper audience because of communication fatigue. Sales people have a great deal of incentive to not be completely honest about the true cost of their products and services because a better-sounding but partially dishonest offer will most likely be chosen to be reviewed or considered for purchase over an offer that is completely transparent at the beginning.

Managing incoming unsolicited communications with existing methods has entailed significant tradeoffs: lost time in the form of communicating with sales people; deleting or simply marking as “spam” email communications; trying to interpret what an offer or proposal is with only partial information; conducting multiple exchanges in order to ascertain basic knowledge of the offer or proposal, etc. Additionally, the faster one manages the communications (through deletion, blocking, etc.) the less value is potentially derived by the knowledge attempting to be communicated, through either never understanding what the offer is, or expending a significant amount of time trying to understand the offer. However, even if a company has found a way to easily and quickly get the information they need, there is still no visibility into whether a proposed deal is competitively priced versus other proposed deals proposed to other companies by the same or different vendor(s).

Managing outgoing unsolicited communications with existing methods also has significant tradeoffs: often the sales person has no effective way of understanding what the client is looking for; knowing what format to present the information in; or ensuring the right person within an organization is informed of the offer. The sales person transmits, in unstructured and unsolicited format, a sales offer.

Resolving these challenges are impossible in a non-machine context. For example, application of heuristic or deterministic rules or the implementation of machine learning and natural language recognition algorithms become important to the management of unsolicited communication, as well as the ability to properly sort, filter, “pause” (e.g., temporarily or permanently block) communication in advance of presentment to a human decision maker is critical. Moreover, a platform providing similar services to multiple organizations may make use of what would otherwise be fragmented data, to create a large data set of unsolicited communication, in order to further train detection algorithms and select communications for elevation to a human decision maker, pausing, and/or deletion. Furthermore, emergent trends across regions, industries, and types of goods or services being sold may become evident through the advantageous leveraging of network effects such that a platform captures a significant volume of communication among similar senders and receivers, facilitating analysis and decision-making and enabling greater transparent price comparison among offers in order to establish market norms.

Discussed further herein is a unsolicited offer management system that may be provided as a software as a service to manage unsolicited communications. Various additional features—both human and machine-related—may be realized. For example, such a system saves a significant amount of time, not just on first contact, but on an ongoing basis, and provides data on whether or not an unsolicited offer is competitively priced. Such a system adds incentives for sales people to put their best offer forward to the potential customer at the very start of the sales process, and avoids unnecessary human-to-human interaction. Such a system adds incentives for sales people to be honest, transparent, and act in good faith with the potential customer, prior to the beginning of any human-to-human interaction, making such interactions more efficient, and ameliorating the data load on electronic resources associated with excessive interactions or with communication unlikely to lead to a transaction.

Further aspects may include compelling a sales person to provide specific information about their product/service/proposal, removing incentive for and preventing a sales person from cold calling, emailing, or walking in to an organization on an ongoing basis to fatigue the potential customer into making a decision (in effect, marking walk-ins, or cold calls as “spam” for extended periods, or indefinitely, based on the organization's preference), and removing the ability of a solicitor to effectively pit employees of a targeted company against one another, because the electronic platform provides visibility among decision makers at the targeted company of the actions of the solicitor and in-platform responses of other decision makers. Moreover, by electronically capturing institutional knowledge across the entire institution regarding unsolicited incoming communications, continuity from solicitation to solicitation is maintained over time. Furthermore, consolidation of such communication onto an common electronic platform makes it more likely that offers from sales people will be seen by the correct person within an organization. Finally and importantly, such a tool allows for the management of sales offers at both a local and central location.

Aspects of the disclosed system and method provide various features for sales persons as well. For example, provision of such a system enables sales persons to contact organizations in a uniform way, answer questions specifically required by the receiving organization to help with decision-making, designate who an offer should be viewed by in the organization, manage all of their outgoing offers in a centralized place and to know when the outgoing offers have been seen by the organization, and to visually stand out if associated with a minority-owned institution or other unique employer for instance, by provision of electronic tags, badges, and/or the like.

Various different workflows through systems and methods disclosed herein are provided. One such example workflow is as follows. First, a solicitor (also called a “sales person”) registers. For instance, the solicitor provides various personal information, such as business affiliation, product(s) or service(s) offered, contact information, and/or the like. Moreover, a form is presented, containing required fields, whereby a solicitor is required to disclose complete pricing information, advantageously forcing full disclosure prior to allowing initial contact (which would be impossible among humans, wherein even the strongest negotiator would require initial human contact before being able to force full pricing disclosure). Full price disclosure may include aspects such as a cost of product/service, cost of add-ons, cost of maintenance, costs of re-fills, etc., and full disclosure is achievable because the form is the only avenue available for unsolicited offers to enter through.

Thereafter, the system may establish, over time, a network of organizations and sales people using a unified platform and data requirement so that pricing, features and other aspects of an offer can be compared across the entire system. This highly-comparable data can then be analyzed by the system to help organizations make purchasing decisions. Moreover, there is provided a ready mechanism of clear notice that any deceptive action or omission of relevant pricing/service information acts to the detriment of the solicitor's good standing, countering efforts at deception, and enforced by mechanisms that can act to the detriment of the solicitor's good standing if they are dishonest, malicious, or incompetent (ratings, paused communications, etc.), and ones that act to their benefit for desired, honest, customer-service-based behavior. Further, such a system operates to effectuate the conversion of unstructured sales information otherwise receivable from a sales person into relevant structured data by enforced forms that must be filled by the sales person.

Further of note, such a system and method provides a dashboard for the organizational user (receiving end) to manage the processing of the communications, and a “paused” zone that further solicitation offers can be sent to for periods of time or indefinitely so the organization may selectively ignore them. Universal or near-universal enforcement of the use of the service by the organization captures all or nearly-all unsolicited communication, facilitating distributed, organization-wide, informational transparency.

In various instances, an organization signs up for an account (an “organization account”) and chooses a URL for their organization, e.g. simplelobby.com/organizationname (“URL”). The person signing the organization up gets an organization user account with personal sign-in information for managing the organization's account. Additional organization user accounts can be added to help manage and process the incoming communications. Any solicitor attempting to make unsolicited contact with that organization is directed to the URL associated with the organization account. To correspond via an interface at the URL, the solicitor must also obtain an account (a “sales account”). Once there, if the solicitor does not have a sales account, the solicitor may sign up for an account.

Having obtained a sales account, the solicitor may upload details of the offer begin proposed. Rather than uploading freeform or unstructured data, such as commonly characterizes email, the details must be provided in a provided fillable form with specific fields that loads at the URL. This encourages an honest and transparent proposal.

Authorized members of the receiving organization can then manage these incoming communications (which are now structured information) via a dashboard available to the organization account. Because the system supports a plurality of organizations and plurality of solicitors, aggregate data is available for analysis. For example, such data may be parsed for emergent trends, filtered based on criteria such as location, price, etc., and otherwise arranged to provide for transparency with respect to relevant market conditions. In this manner, organizations may evaluate the terms of an offer relative to other offers.

The system may provide the organization with additional information about the sales person to supplement the structured data provided in the offer. For instance, the system may inform the organization user if the vendor that the sales person is representing is minority owned, who the proposal would best be viewed by in their organization, other information that can help a proposal stand out, etc. Some of these may be presented visually to provide advantages to certain sales people (for paid accounts, or encouraged behavior, or situational realities). For example, sales accounts may earn “badges” or other visual distinctions for encouraged, honest, desirable behavior on the platform.

Organizations may also provide or view additional information such as additional information about the offer, the sales person, the product, online vendor ratings, price comparisons, sales person rating, and other useful or informative information to help in evaluating or managing the communication. This information supplements the structured data provided in the offer and may be visible to other organizations making similar decisions regarding offers from that sales person, regarding that product, or from other sales persons. For instance, organization users may “rate” the sales person in the system for both internal and external consideration. Even if a rating is done for internal purposes, the system may isolate public facing and private facing data so that aggregated and anonymized ratings may inform other organizations regarding a sales person.

Organization users may contribute various further types of information, for instance, an organization user may assign or re-assign an incoming communication to another member of the organization for their review and processing. An organization user may associate metatags with offers to designate them for a department, or as product type, or arbitrarily to suit organization-specific needs. Organization users may sort and filter offers based on any available data. For example, public facing data associated with any organization and private facing data associated with the organization doing the sorting, may be available. Moreover, because communication between sales accounts and organization accounts may be permitted, organizations having an organization account may utilize the system to manage and organize communication. For instance, an organization user may archive an incoming communication, delete an incoming communication, or “pause” the sender. In further instances, because multiple senders may be associated with a same vendor, an organization user may pause multiple senders such as to pause all sales people representing the same vendor. Pausing senders will be discussed further elsewhere herein. In various instances “pausing” a user/organization means further communications from them go to a “paused” section (either for a duration of time or indefinitely, depending on the organizational user's choice). The organization user can annotate the reason for “pausing,” such as for other responsible parties within the organization, for other organizations, or for a subset thereof. Such annotations may include “Products not needed,” “Prices too high,” “Sales person unprofessional,” custom reasons, etc.

Organization users may transmit their own messages. For instance, the system provides two way communication between accounts, including organization accounts and sales accounts. In addition, messages may be sent and received through the platform via other mechanisms. For instance, the system may include a plugin, such as to interface with Outlook, web email client, web browser, or other computer software which can connect the system to familiar interfaces. In various embodiments, an email client plugin is implemented. The system may collect information on which emails are being responded to via that plugin to either create a spam filter (to prevent repeat emails from the same address), or to flag future emails as potentially containing an unsolicited offer. For instance, by having access to communication sent by all users of the system, machine learning mechanisms, deterministic rules, heuristic rules, and/or combinations thereof may identify patterns associated with unsolicited offers and thus improve classification of messages while maintaining privacy among users. In various instances, operational efficiency may be improved and network congestion may be ameliorated by the provision of pre-set messages sendable by organization users or by sales people, in addition to free-form and/or custom messages. In various embodiments, organizations may set preferences such as to permit only messages corresponding to a pre-established template, thereby reducing the computational load associated with parsing unstructured data, as well as to facilitate the automation of such communication.

Messages sent by organization users may be made visible to the sales person (and vice versa) as a method of communicating back and forth. Other methods for communication, such as separate chat windows, annotation tools, etc. may also be employed. Each offer contains an automatically-updating audit trail showing the status changes, assignment changes, logged messages, and any other relevant updated information and when they were made. The organization may set which updates the sales user will be able to see. Messages may be retained, allowing organization users to search through their archive of previous offers to identify past discussions and actions surrounding purchasing decisions.

Just as the system facilitates effective communication that addresses needs of the organization users, the system similarly provides features advantageous to sales people. For instance, a dashboard is provided for sales accounts to enable management of outgoing proposals to various companies (e.g., to various organization accounts) who have organization accounts on the system. In various embodiments, the dashboard displays data such as the terms of transmitted offers, the elapsed time since transmission of an offer, whether the offer was viewed, the status of review and or approval of the offer, reasons for rejection of the offer, if their account is “paused” by any organization users and if so, reasons for the pause, as well as other information including information collected through the interactions of others with this and other organizations to determine whether further interaction with the organization is advantageous. Moreover, the dashboard facilitates the logging of messages associated with each offer. This dashboard data may be wholly or partially visible to both the sales account holder, the organization accounts interacting therewith, and/or other accounts, such as that of a supervisor, or a parent entity, or the like.

The dashboard further facilitates the management of multiple offers by allowing sales people to add an inventory of their products/services for easy inclusion in future offers. Sales people may view businesses on a map and track pending offers visually, as well as perform sales-route mapping to facilitate improved efficiency.

As mentioned, an organization account may “pause” one or more sales accounts. If a sales account is “paused,” it may still generate correspondence to contact the organization having the organization account, however their communications will be quarantined in a designated “paused” area in the dashboard of the organization account. Messages going into the paused area do not generate the same alert indication generated by messages not going into the paused area. Moreover, the system provides an option for organization accounts to flag the sales accounts associated with sales persons who make unauthorized off-platform attempts at communication.

Moreover, circumvention of paused status by sales persons is diminished and accuracy and precision of identifying such senders improved relative to that of email. For example, when marking something as ‘spam’ in an email program, one typical must either block a specific email address (e.g., abc@xyz.com), or a whole domain (e.g., xyz.com). In the former case the sales person could simply change their email address, and in the latter, it is sometimes dangerous to block the whole domain because other types of important emails could originate from that domain.

In contrast, a system as provided herein diminishes circumvention and maintains accurate and precise identification of senders who may attempt to circumvent paused status because the sales person must sign up for an account and communications come from the account and not an associated email address. Moreover, the system is capable of preventing a sales person from signing up for other accounts by preventing two accounts with the same first and last name, phone number, and organization name (and minor variances) from being created. Because faking this information could affect the relationship with the potential customer, it would be difficult to assume false identities in order to circumvent paused status. Moreover, paid features would not transfer to multiple accounts, further discouraging nefarious spam transmission and corresponding network congestion. Furthermore, a profile picture may be required, adding another mechanism of identifying an individual. For instance, machine image recognition technology may be implemented to limit each individual human, as identified through an image, to a single account.

A organization account holder may also change the associated URL from time to time. For instance, too many communications from far away or otherwise undesired vendors may begin to arrive at a well-known URL, prompting an organization account user to make such a change.

In various embodiments, relationships may be established among organization accounts and/or sales accounts. For instance, some accounts may be a supervisor or a parent entity of a different account. Each account may have multiple parent or child accounts, and each parent account may access the offers transmitted to each linked child account. Various mechanisms to establish a linkage are contemplated. For instance, each account may have a unique electronic identifier (e.g., an ID number), or each account may include unique information such as a name and address. These, or any other mechanism of identifying an account may be provided to link accounts.

Moreover, a parent account linked to a child account may override various activities in the child account from time to time. For instance, a parent account may “pause” offers at all levels (sibling branches or parent) to prevent a sales person from providing offers to any representatives of the parent and potentially many child organizations. This allows for infinite and highly-flexible levels of organizational complexity. Additionally, metatags associated with offers can be screened according to rules set by a parent organization, so that some decisions regarding whether to accept an offer are limited to certain accounts, while other decisions regarding whether to accept an offer are limited to other accounts. For example, offers regarding IT services may be screened so that only a parent organization interacts with these offers.

Numerous other features may be contemplated for such a platform. A few example features include charging each solicitor per offer transmission to limit low value communication, limiting the number or rate of communications transmitted by each account or set of linked accounts. Allowing access to an account dashboard and/or messages through a mobile device (e.g. smartphone, table) application, a native computer application, a physical kiosk, an automated voice system, and the like may be permitted. Facilitating an organizational account to contact sales accounts and solicit offers may be permitted. Moreover, the provision of offers and the solicitation of offers may be limited by geography, price, description, key words, etc. Further features may control the availability of communication between sales and organization accounts. For example, an a organization account receiving a large number of incoming communications may require sales accounts to enter a unique code, which could either be automatically generated and distributed on a per-contact basis, or have a single code that could be expired as needed, or a combination of the two.

Moreover, such a system may be implemented in other market contexts. For example, other relationships, such as politician and constituent communication may be managed, the organization account and politician account being analogous and the sales account and constituent account being analogous. The system may have analogous personal use accounts similar to organizational accounts so that door-to-door solicitors are directed to an individual's personal use account.

Yet furthermore, additional features may be provided to facilitate the actual deal-making through to execution (e.g. handling of all legal and financial aspects, including but not limited to contract execution, payment/billing for goods and services, donation transfers, etc.). A system may include social aspects and tools built into it for the purpose of networking. For example sales people may have a profile page to market themselves and their products, and ways of communicating with each other and businesses. The system may provide tools for authenticating, verifying, certifying, organization/business information and its relationship to the user claiming to be a part of that organization, to further eliminate spoofing. The system may provide ways for sales people and organizations to have self-directed business networking and include tools for sales people to demo their product either with uploaded videos or through live online demonstrations with ways to schedule and coordinate these demonstrations. The system may permit solicitation of reviews, which could then be associated with a person, organization, or product.

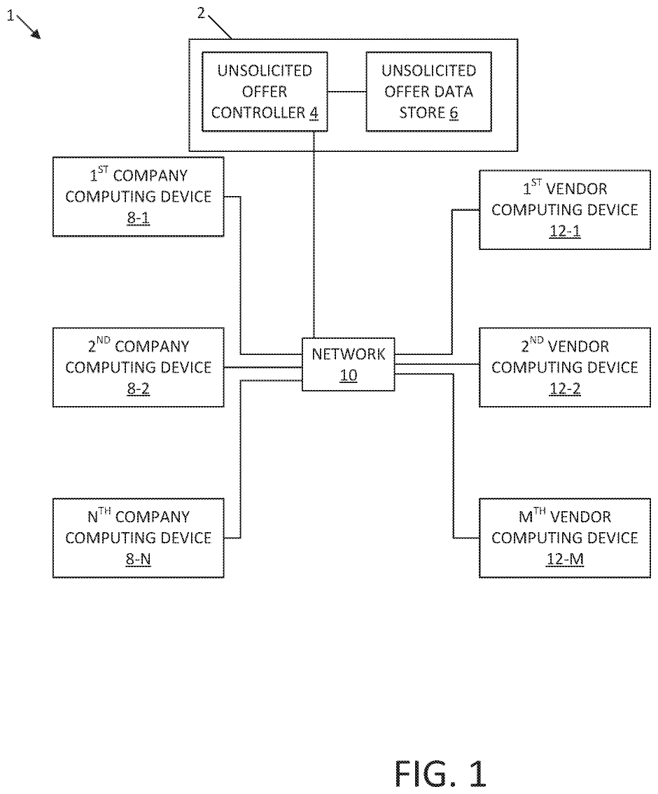

Having completed a general review of the systems and methods for unsolicited offer management, attention is directed to FIG. 1 for a discussion of specific components of an example embodiment of a system and method for unsolicited offer management 2 operating in a context environment 1. A context environment 1 comprises the larger ecosystem of vendors and companies that acquire sales accounts and organization accounts respectively and connect via a network 10 to the system 2. For example, a system 2 may be connected to a network 10 such as the internet. A first company computing device 8-1, a second company computing device 8-2, and any number ‘N’ of computing devices of different companies, such as a Nth company computing device 8-n may connect to the network 10 as well. Via the network 10, each company is in operative communication with the system 2. Similarly, a first vendor computing device 12-1, a second vendor computing device 12-2 and any number ‘M’ of vendors with computing devices, such as a Mth vendor computing device 12-m may connect to the network 10 as well. Via the network 10, each vendor is in operative communication with the system 2. Furthermore, the system 2 provides a communication gateway among vendor computing devices 12 and company computing devices 8, selectively enabling and disabling communication and monitoring communication to provide services as discussed herein.

The system 2 may comprise a system for unsolicited offer management 2, as mentioned. The system for unsolicited offer management 2 may be structured and arranged to selectively enable communication between one or more vendor computing device 12-1 using a sales account and one or more company computing device 8-1 using an organization account. The system 2 may selectively disable and/or redirect communication among vendors and companies (among sales accounts and organization accounts) depending on deterministic rules, heuristic rules, and/or depending on manual selections within a dashboard.

The system 2 may comprise a unsolicited offer controller 4. The controller 4 implements the rules, as mentioned. The system 2 may include a data store 6. The data store 6 stores the rules, and further stores historical and aggregated data as mentioned elsewhere herein.

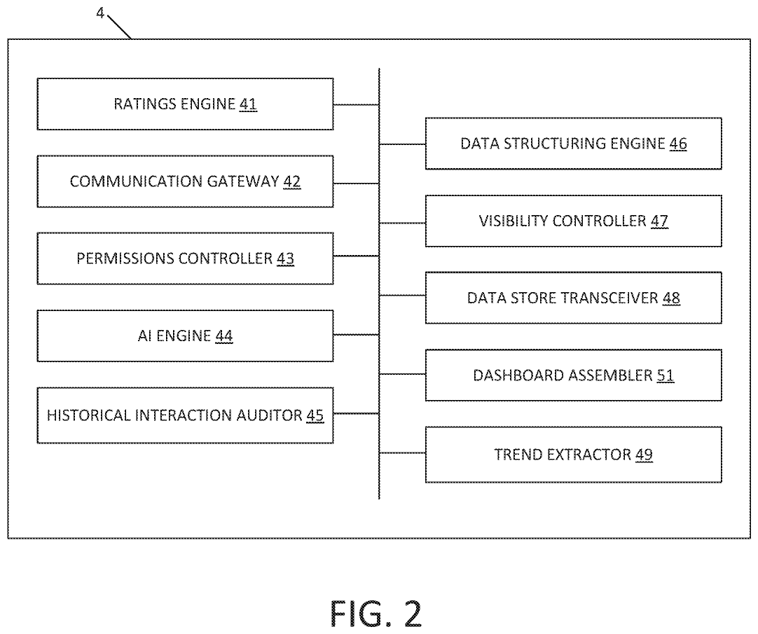

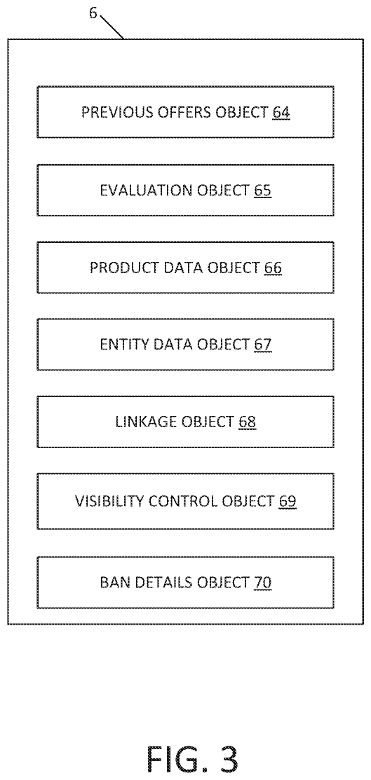

Directing attention now to FIG. 2, logical aspects of the unsolicited offer controller 4 are detailed and directing attention now to FIG. 3, logical aspects of the unsolicited offer data store 6 are detailed. Turning specifically to FIGS. 1 and 2, a unsolicited offer controller 4 may comprise different logical modules structured and arranged to perform various of the features discussed above. For example, a unsolicited offer controller 4 may include a ratings engine 41. A ratings engine 41 is configured to receive rating information from a first dashboard of a first user and store the ratings information in the unsolicited offer data store 6 in a data structure linking the rating information to at least one account or product. For example, an organization account may have a dashboard where a user can rate a sales person connected with a sales account that is sending unsolicited and/or solicited communication to the organization account. Thus a ratings engine 41 of a unsolicited offer controller 4 may write to an evaluation object 65 data representing an evaluation (e.g., a rating) of an account or product. The evaluation object 65 may be linked to a product data object 66 associated with a specific product, or may be linked to an entity data object 67 representing an account. This linkage may be stored in a linkage object 68. In this manner, ratings may be stored for future use. Moreover, each data object may have a public facing aspect and a private facing aspect. Thus, the rating itself may be publically available across all company computing devices 8-1, 8-2, 8-n and/or all vendor computing devices 12-1, 12-2, 12-m while the identity of the party providing the rating may be available only to a subset of the companies or vendors.

A unsolicited offer controller 4 may include a communication gateway 42. The communication gateway 42 is configured to receive communication from an organization account or a sales account and then transmit that communication to a sales account or organization account that it is intended for. However, the communication gateway 42 may flag the communication as paused or not-paused, or may discarded the communication so that it is never delivered, in response to instructions from a permissions controller 43.

A unsolicited offer controller 4 may include the aforementioned permissions controller 43. As mentioned above, to prevent excessive messaging from vendors to companies, companies may put vendors in a “paused” category so that their messages are delivered to a separate area of the dashboard. The communication gateway 42 is configured to interoperate with the permissions controller 43 to write to a visibility control object 69 linked by a linkage object 68 to an entity data object 67 to set an entity to paused or not-paused status. Moreover, the communication gateway 42 is similarly configured to read the visibility control object 69 to determine whether to authorize the communication gateway 42 to pass a message, to flag a message as paused, or to discard the message.

A unsolicited offer controller 4 may include a data structuring engine 46. As mentioned, when a sales account prepares an offer for transmission to an organization account, the sales account must present the offer as structured data, with all required data fields filled. Moreover, all required data fields must be filled with relevant data. For instance, a price field must be filled with numerals, not dashes, or alphabet characters such as “TBD.” The data structuring engine 46 creates the structured form soliciting each datum in a structured way. In this manner, interpretive challenges such as those associated with free form data entry are ameliorated.

A unsolicited offer controller 4 may include a trend extractor 49. A trend extractor 49 analyzes data from the data store 6 and determines trends in the data. For example, trends in communications patterns such as solicitation targets, pricing data, time and date data, data related to terms of agreements, data related to geography of solicitations and/or any other measureable data, as desired. The trend extractor 49 may, in cooperation with an AI engine 44, utilize data from data store 6 for machine training, improving the identification of potentially unwanted messages and the accuracy and precision of the permissions controller 43 in setting such messages to a “paused” status or discarding such messages.

A unsolicited offer controller 4 may have a visibility controller 47. As mentioned, certain data is visible to a subset of sales accounts or organization accounts. For example, a parent organization will have visibility for all accounts of child organizations, whereas a child organization will not have visibility for an account of the parent organization. Moreover, certain data is public facing, meaning available to unrelated third parties, though in some instances, in aggregated and anonymized form, and certain data is private facing, meaning only available to certain accounts. For example, a rating by an organization account of a sales account may be aggregated into an average rating available to all organizations, but the specific contents of the rating may be visible only to the rating and rated parties and the identity of the rating party may only be available to the rating party and its parent organizations. The visibility controller 47 may be structured and arranged to set a visibility control object 69 in connection with any other object in the data store 6 and instruct a linkage object 68 to associate the visibility control object 69 therewith, such that visibility of data may be managed from account to account.

As mentioned, the unsolicited offer controller 4 may include a permissions controller 43. The permissions controller 43 may regulate the access of different dashboards of different users—for instance, a specific organization account or a specific sales account—to different data. Moreover, as each data object may have a public facing portion and a private facing portion, consequently, different permissions attach to one datum relative to another datum. Consequently, the permissions controller 43 compares the permissions associated with a dashboard attempting to access data, to the permissions attached to each datum, and grants or limits access thereto. Moreover, in various embodiments, a ban details object 70 is attached by a linkage object 68 to an entity data object 67. A ban details object 70 contains data corresponding to conditions of a “ban” applied to an organization or sales account. A ban corresponds to a complete prohibition of access by the organization or sales account to a specific datum, a specific type of data, or a specific other account. For example, an organization account may cause a ban details object 70 to attach to a sales account completely barring the sales account from any contact with the organization account. Moreover, a ban details object 70 may be attached to a sales account or an organization account preventing all access of the account to the system 2.

The unsolicited offer controller 4 may include a data store transceiver 48. The various data stored in the data store 6, for instance, the objects discussed herein, must be located and their contents read in order for the data therein to be received into the working memory of the controller 4. The data store transceiver 48 is configured to access the data store 6, locate and read this data. Moreover, the data in the data store 6 is changed, updated, or supplemented from time to time. The data store transceiver 48 receives corresponding instructions from other aspects of the controller 4 and accesses the data store 6 to make the changes, updates, and supplements.

The unsolicited offer controller 4 may include a dashboard assembler 51. The dashboard assembler 51 ingests data from other aspects of the controller 4 and data provided from the data store 6 and structures the data for visual depiction on a human readable interface for viewing by a user of a sales account or an organization account. In this manner, a sales account dashboard or an organization account dashboard is generated.

Finally, the unsolicited offer controller 4 includes a historical interaction auditor 45. The historical interaction auditor 45 comprises a logical module of the controller 4 structured and arranged to load historical interactions of a sales account or an organization account with the system 2 and with other accounts thereon. The historical interaction auditor 45 may structure data representative of the historical interactions for visual display by the dashboard assembler 51 on a user readable interface. Moreover, the historical interaction auditor 45 may interoperate with the trend extractor 49 to identify patterns in historical interactions for display on a user readable interface. In this manner, users of the sales account or organization account may modify future interactions with the system or other accounts thereon in view of past interactions. For instance, the previous offers sent by a sales account may be stored in a previous offers object 64 in the data store 6. These previous offers may be desired to be processed by a trend extractor 49 so that the sales account user may recall historical pricing of offers made to a specific organization account. Alternatively, these previous offers may be desired to be processed by a trend extractor 49 in connection with the historical interaction auditor 45 so that an organization account user may recall anonymized and aggregated data regarding offers sent by sales accounts to other organization accounts of interest, such as other organization accounts in the same geographic region. Thus one may appreciate that many different uses for historical data.

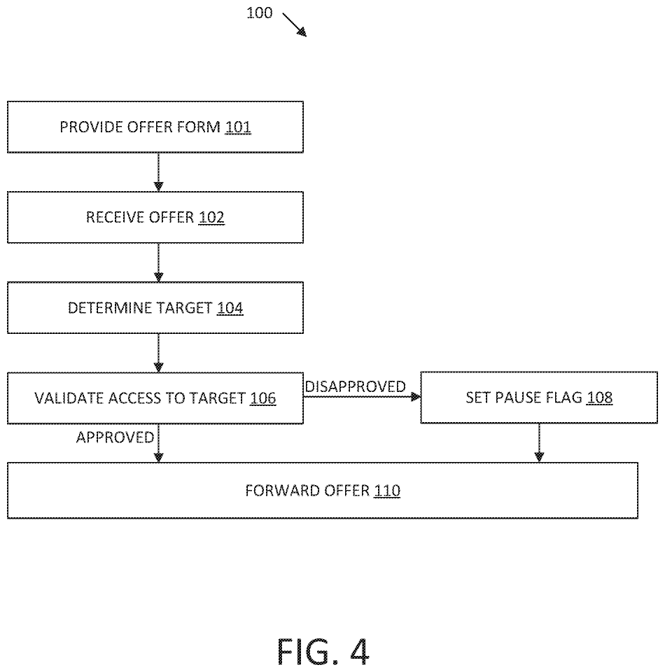

Having discussed aspects of a unsolicited offer management system 2 in detail, attention is now directed to FIG. 4, in addition to ongoing attention being directed to FIGS. 1-3, for a discussion of a method 100 of unsolicited offer management. In various embodiments, a data structuring engine 46 of a unsolicited offer controller 4 prepares first screen display objects and a communication gateway 42 transmits first screen display objects to a dashboard of a first account comprising a sales account. The first screen display objects comprise a fillable form structured and arranged to capture structured data comprising an offer. Stated differently, the system may provide an offer form to a solicitor (block 101).

The user of the sales account may enter data into the fields of the fillable form, creating a first structured offer object. A first structured offer object comprises the structured data entered into the fillable form and containing the offer. The first structured offer object is thus received by the communication gateway 42 of the unsolicited offer controller 4. Stated differently, the system receives the solicitor's offer (block 102).

The communication gateway 42 of the unsolicited offer system controller 4 parses the data comprising the first structured offer object and determines at least one organization account to which the first structured offer object is directed by the sales account (first recipient account). For instance, the first structured offer object may be addressed to a specific organization account. In further instances, the first structured offer object is addressed to a set of specific organization accounts meeting a first criteria. For instance, the first criteria may be a geographic region, an industry, a market sector, and/or any other factor as desired. Stated differently, the system determines a target (block 104).

The communication gateway 42 may validate the access rights of the sales account to send the first structured offer object to the at least one organization account to which the first structured offer object is directed by the sales account. For instance, the communication gateway 42 may access a visibility control object 69 stored in the data store 6 and connected by a linkage object 68 to an entity data object 67 of the sales account. The visibility control object 69 indicates the status of the sales account—for instance, whether the sales account is or is not “paused” for each of the at least one organization account(s) to which the first structured offer object it is directed. Stated differently, the system validates access to the target (block 106).

In response to access not being authorized (also called, “disallowed,” “disapproved,” or “paused”), the communication gateway 42 sets a pause flag within the first structured offer object (block 108). In various embodiments, the communication gateway 42 forwards the first structured offer object to the organization account, so that based on the pause flag, it is quarantined in an display area for paused communication (block 110). In further embodiments, rather than setting a pause flag, the first structured offer object is discarded.

In response to access being authorized (also called, “allowed,” “approved,” or “not paused”), the communication gateway 42 forwards the first structured offer object to the organization account without having set the pause flag. Consequently, the first structured offer object is displayed in the organization account dashboard (block 110).

As used herein, the term “network,” such as with respect to a network which may comprise at least a portion of network 10 provided in FIG. 1, includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PM, GPG (GnuPG), and symmetric and asymmetric cryptosystems.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., Facebook, YouTube®, AppleTV®, Pandora®, xBox®, Sony® Playstation®), a uniform resource locator (“URL”), a document (e.g., a Microsoft Word® document, a Microsoft Excel® document, an Adobe .pdf document, etc.), an “ebook,” an “emagazine,” an application or microapplication (as described herein), an SMS or other type of text message, an email, Facebook, twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include Facebook®, Foursquare®, Twitter®, MySpace®, LinkedIn®, and the like. Examples of affiliate or partner websites include American Express®, Visa®, Google®, and the like. Moreover, examples of mobile device communications include texting, email, and mobile applications for smartphones.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; utility company data; institution data; regulatory agency data; and/or like data useful in the operation of the system. As those skilled in the art will appreciate, user computer may include an operating system (e.g., Windows NT®, Windows 95/98/2000®, Windows XP®, Windows Vista®, Windows 7®, OS2, UNIX®, Linux®, Solaris®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as determining or selecting, which are commonly associated with mental operations performed by a human operator. No such capability of a human operator is necessary, possible, or desirable in most cases, in any of the operations described herein. Rather, the operations may be machine operations not performable by mere human activity.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, and optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs) are implemented. Implementation of the hardware state machine so as to perform the functions described herein will be apparent to persons skilled in the relevant art(s).

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST”s (National Institute of Standards and Technology) definition of cloud computing at http://nvlpubs.nist.gov/nistpubs/Legacy/SP/nistspecialpublication800-145.pdf (last visited August 2019), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Practitioners will also appreciate that there are a number of methods for displaying data within a browser-based document. Data may be represented as standard text or within a fixed list, scrollable list, drop-down list, editable text field, fixed text field, popup window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C #, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Systems, methods and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, and C” or “at least one of A, B, or C” is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then,” “next,” etc., are not intended to limit the order of the steps; these words are simply used to guide the reader through the description of the methods. Although process flow diagrams may describe the operations as a sequential process, many of the operations can be performed in parallel or concurrently. In addition, the order of the operations may be rearranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or the like, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory, processor-readable storage media may be any available media that may be accessed by a computer. By way of example, and not limitation, such non-transitory, processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory, processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

1. A method of unsolicited offer management comprising:
receiving, by a communication gateway of an unsolicited offer controller, a first structured offer object from a first account;
parsing, by the communication gateway, the first structured offer object to determine at least one first recipient account for the first structured offer object;
validating, by the communication gateway, access rights of the first account to transmit the first structured offer object to the at least one first recipient account; and
in response to the access rights being not valid, setting a pause flag within the first structured offer object.

2. The method of unsolicited offer management according to claim 1, further comprising:
preparing, by a data structuring engine of the unsolicited offer controller and prior to the receiving the first structured offer object, first screen display objects comprising a fillable form structured and arranged to capture structured data; and
transmitting, by the communication gateway of the unsolicited offer controller, the first screen display objects to a dashboard of the first account,
wherein the first structured offer object comprises structured data captured by the fillable form.

3. The method of unsolicited offer management according to claim 1, further comprising discarding the first structured offer object in response to the pause flag being set.

4. The method of unsolicited offer management according to claim 1, further comprising transmitting the first structured offer object to the at least one first recipient account.

5. The method of unsolicited offer management according to claim 4, further comprising quarantining, by the at least one first recipient account, the first structured offer object in a screen display area for structured offer objects having the pause flag set in response to receiving, by the at least one first recipient account, the first structured offer object with the pause flag set.

6. The method of unsolicited offer management according to claim 4, further comprising:
retrieving a previous offers object from a data store; and
extracting, by a trend extractor of the unsolicited offer controller, at least one price trend from the previous offers object, and transmitting by the communication gateway of the unsolicited offer controller, data representing the at least one price trend to the at least one first recipient account.

7. The method of unsolicited offer management according to claim 6, further comprising displaying, by the at least one first recipient account, data representing a comparison of the at least one price trend to the first structured offer object on a user readable screen display.

8. A non-transient computer readable medium containing program instructions for causing a computer to perform a method of unsolicited offer management comprising:
receiving, by a communication gateway of an unsolicited offer controller, a first structured offer object from a first account;
parsing, by the communication gateway, the first structured offer object to determine at least one first recipient account for the first structured offer object;
validating, by the communication gateway, access rights of the first account to transmit the first structured offer object to the at least one first recipient account; and
in response to the access rights being not valid, setting a pause flag within the first structured offer object.

9. The non-transient computer readable medium according to claim 8, wherein the method of unsolicited offer management further comprises:
preparing, by a data structuring engine of the unsolicited offer controller and prior to the receiving the first structured offer object, first screen display objects comprising a fillable form structured and arranged to capture structured data; and
transmitting, by the communication gateway of the unsolicited offer controller, the first screen display objects to a dashboard of the first account,
wherein the first structured offer object comprises structured data captured by the fillable form.

10. The non-transient computer readable medium according to claim 8, wherein the method of unsolicited offer management further comprises discarding the first structured offer object in response to the pause flag being set.

11. The non-transient computer readable medium according to claim 8, wherein the method of unsolicited offer management further comprises transmitting the first structured offer object to the at least one first recipient account.

12. The non-transient computer readable medium according to claim 11, wherein the method of unsolicited offer management further comprises:
quarantining, by the at least one first recipient account, the first structured offer object in a screen display area for structured offer objects having the pause flag set in response to receiving, by the at least one first recipient account, the first structured offer object with the pause flag set.

13. The non-transient computer readable medium according to claim 11, wherein the method of unsolicited offer management further comprises:
retrieving a previous offers object from a data store; and
extracting, by a trend extractor of the unsolicited offer controller, at least one price trend from the previous offers object, and transmitting by the communication gateway, data representing the at least one price trend to the at least one first recipient account.

14. The non-transient computer readable medium according to claim 13, wherein the method of unsolicited offer management further comprises:
displaying, by the at least one first recipient account, data representing a comparison of the at least one price trend to the first structured offer object on a user readable screen display.

15. An unsolicited offer management controller comprising a communication gateway, wherein the communication gateway is configured to:
receive a first structured offer object from a first account;
parse the first structured offer object to determine at least one first recipient account for the first structured offer object;
validate access rights of the first account to transmit the first structured offer object to the at least one first recipient account; and
set, in response to the access rights being not valid, a pause flag within the first structured offer object.

16. The unsolicited offer management controller according to claim 15, further comprising:
a data structuring engine connected to the communication gateway and configured to prepare, prior to the receiving the first structured offer object, first screen display objects comprising a fillable form structured and arranged to capture structured data,
wherein the communication gateway is configured to transmit the first screen display objects to a dashboard of the first account, and
wherein the first structured offer object comprises structured data captured by the fillable form.

17. The unsolicited offer management controller according to claim 15, wherein the communication gateway discards the first structured offer object in response to the pause flag being set.

18. The unsolicited offer management controller according to claim 15, wherein the communication gateway transmits the first structured offer object to the at least one first recipient account.

19. The unsolicited offer management controller according to claim 18, further comprising:
a data store transceiver configured to retrieve a previous offers object from a data store; and
a trend extractor configured to extract at least one price trend from the previous offers object,
wherein the communication gateway transmits data representing the at least one price trend to the at least one first recipient account.

20. The unsolicited offer management controller according to claim 19, wherein the at least one first recipient account displays data representing a comparison of the at least one price trend to the first structured offer object on a user readable screen display.
